(19) United States
(12) Patent Application Publication
(10) Pub. No.: US 2007/0024891 A1
(43) Pub. Date: Feb. 1, 2007

(54) Image forming apparatus and control method thereof

(75) Inventor: Yong-im Kim, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/485,469

(22) Filed: Jul. 13, 2006

(30) Foreign Application Priority Data
Jul. 26, 2005 (KR) 2005-68101

(51) Int. Cl. G06K 15/00

(52) U.S. Cl. 358/1.14; 358/1.13

(57) ABSTRACT

An image forming apparatus and a control method thereof that provides a convenient print resume when printing is halted. The control method of the image forming apparatus includes obtaining image data to be printed which are selected among image data stored in a memory card, printing the selected image data, preparing a print list for the selected image data, if a printing operation is interrupted, preparing a list of image data suspended from printing and storing the list of unprinted image data. Therefore, although the printing operation may be interrupted before all image data to be printed are completely printed, the list of image data suspended from printing stored in the memory card makes it more convenient for a user to resume the printing operation on the unprinted image data without repeating the routine, namely, selecting image data to be printed and resetting the print options, to print the unprinted image data afterwards.

### CROSS-REFERENCE TO RELATED APPLICATIONS

This application claims priority under 35 U.S.C. §119 from Korean Patent Application No. 2005-68101, filed on Jul. 26, 2005, the entire content of which is incorporated herein in its entirety and by reference.

### BACKGROUND OF THE INVENTION

1. Field of the Invention

The present general inventive concept relates in general to an image forming apparatus and a control method thereof, and more specifically, to an image forming apparatus to store a list of unprinted image data in a memory card and to continue the printing operation later based on the list of unprinted image data, and a control method thereof.

2. Description of the Related Art

An image forming apparatus such as a photo printer can perform a printing operation on image data stored in a memory card which is used as a recording medium of an image photographing apparatus such as a digital camera. In general, users can continuously store image data until a storage capacity of the memory card is filled, and then print a large amount of image data stored on the full memory card at one time.

Because the printing operation for each image takes some time to complete, the users face a long wait time until all the image data of the full memory card are completely printed. Unfortunately, however, the waiting time for the users is expected to become longer as technical advances continuously increase the storage capacity of new memory cards available to users. Partly because of the long wait time, some users give up on the print operation before all of selected image data are completely printed.

Additionally, when printing is interrupted in the middle of a printing operation, a print list containing the selected image data to be printed and specific print options set for the print data are all deleted from the image forming apparatus. Therefore, if the user wants to print the image data stored in the memory card again, the user has to select the image data to be printed once again and then set the print options once again.

Furthermore, when the user wants to print only the image data suspended from the previous printing, the user first needs to manually separate image data that are already printed from unprinted image data and then make the image forming apparatus print the unprinted image data only. Consequently, this causes a lot of inconvenience to users.

### SUMMARY OF THE INVENTION

The present general inventive concept provides an image forming apparatus to immediately perform a printing operation on image data suspended from a previous printing process by using a list of unprinted image data stored in at least one of a memory card and a storage unit built into the image forming apparatus, without asking a user to reselect image data to be printed and to reset print options, and a control method of the image forming device.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of controlling an image forming apparatus, including obtaining image data to be printed which are selected among image data stored in a memory card, preparing a print list for the selected image data, printing the selected image data, if a printing operation is interrupted, preparing a list of unprinted image data suspended from printing, and storing the list of unprinted image data.

Printing of the selected image data may further include preparing a list of image data selected from printing.

The list of unprinted image data may be prepared by displaying on a display unit a message asking a user to select whether to prepare the list of unprinted image data and obtaining an affirmative response from the user.

The list of unprinted image data may be stored the memory card and/or a predetermined storage unit provided to the image forming apparatus.

The storing of the list of unprinted image data, the memory card and/or the storage unit may be selected as a storage location for the list of unprinted image data.

The list of unprinted image data may include file names of image data suspended from printing, print options, and a print sequence.

Preparing the list of unprinted image data may include rearranging the print sequence in a manner that the unprinted image data having the same print options are grouped together.

The control method of an image forming apparatus may include receiving a print resume request to print image data on the list of unprinted image data, and executing a printing operation on the image data included in the list of unprinted image data.

The control method may include checking whether the list of unprinted image data is stored in the memory card.

The foregoing and/or other aspects and utilities of the present general inventive concept may also be achieved by providing an image forming apparatus, including a printing unit to perform a print operation according to image data of a plurality of images, a control unit to control the print unit, and a print list preparation unit to prepare an unprinted image list based on a control instruction from the control unit when the print operation stops printing before the print operation for all the image data is completed, the unprinted image list comprises image data of each of the plurality of images not printed in the print operation.

The foregoing and/or other aspects and utilities of the present general inventive concept may also be achieved by providing an image forming apparatus, including a control unit to control a print operation based on a command to print image data, and a print list preparation unit to prepare a print list upon receipt of the command to print image data from the control unit and to prepare an unprinted image list of image data not printed by the print operation upon an interruption of the print operation.

The foregoing and/or other aspects and utilities of the present general inventive concept may also be achieved by providing an image forming apparatus, including a printing unit to print image data, and a print list preparation unit to prepare a list of image data to be printed in a print operation and to prepare a list of unprinted image data when an interruption of the printing of the image data occurs.

The foregoing and/or other aspects and utilities of the present general inventive concept may also be achieved by providing a method of controlling an image forming apparatus, including performing a print operation on image data comprising a plurality of images, interrupting the print operation upon an interruption of the print, generating a list of unprinted image data comprising image data of the plurality of images not printed by the print operation when the print operation is interrupted, and storing the list of unprinted image data to be printed at a later time.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates an image forming apparatus according to an embodiment of the present general inventive concept;

FIG. 2 illustrates a print list prepared by the image forming apparatus of FIG. 1;

FIG. 3 illustrates a list of unprinted image data prepared by of the image forming apparatus of FIG. 1;

FIG. 4 illustrates another list of printed images prepared by the image forming apparatus of FIG. 1;

FIG. 5 is a flow chart illustrating a method of storing the list of unprinted image data in a memory card according to an embodiment of the present general inventive concept; and

FIG. 6 illustrates a method of printing unprinted image data stored in the memory card according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

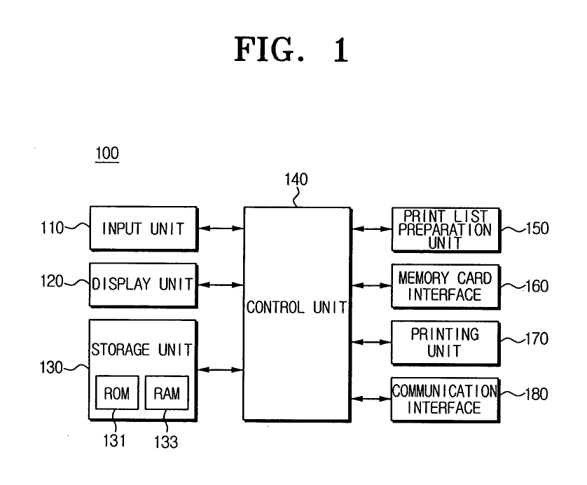

FIG. 1 illustrates an image forming apparatus 100 according to an embodiment of the present general inventive concept.

Referring to FIG. 1, the image forming apparatus 100 includes an input unit 110, a display unit 120, a storage unit 130, a control unit 140, a print list preparation unit 150, a memory card interface 160, a printing unit 170 and a communication interface 180.

The input unit 110 is provided with a plurality of function keys, number keys and alphabet keys. When a user inputs a command for the overall operation of the image forming device 100 or a print command for image data stored in a memory card (not shown), the input unit 110 transfers the command to the control unit 140. Examples of the memory card may include a CF card, SD card, MMC card, XD card, SMC card, etc. Moreover, the input unit 110 receives the command from the user such as an interrupt command (print interrupt request) and a print resume command (print resume request), and transfers these commands to the control unit 140. The interrupt command is input to the control unit 140 as a print interrupt request signal and the print resume command is input to the control unit 140 as a print resume signal.

The display unit 120 displays data such as information on an overall operational status of the image forming apparatus 100 and system information to the outside, under the control of the control unit 140. An LCD panel, for example, may be used as the display unit 120. In addition, the display unit 120 displays, under the control of the controller 140, a list of the image data stored in the memory card so that the user can select image data desired to be printed out. When the user issues the interrupt command through the input unit 110, the display unit 120 displays, under the control of the control unit 140, a message asking the user to select whether to prepare an unprinted image list). Furthermore, the display unit 120 displays, under the control of the control unit 140, a message asking the user to select in which storage location the user wants to store the unprinted image list. In this case, the storage location may be either the memory card or the storage unit 130 of the image forming apparatus 100. However, the user may store the unprinted image list in any appropriate storage device.

The storage unit 130 consists of ROM 131 and RAM 133.

The ROM 131 is a non-volatile memory to store control programs necessary to implement functions of the image forming apparatus 100. A nonvolatile random access memory (NVRAM, not shown) may be used instead of the ROM 131. In a case that the storage unit 130 of the image forming apparatus 100 is chosen as the storage location for the unprinted image list, the NVRAM can store the unprinted image list.

On the other hand, the RAM 133 is a volatile memory to store the image data to be printed that is transmitted from a memory card (not shown) mounted at the memory card interface 160 or from an external equipment (not shown) connected through the communication interface 180, and any data that is generated during the execution of the operation of the image forming apparatus 100. Moreover, the RAM 133 stores a print list prepared by the print list preparation unit 150, and temporarily stores image data transferred from the memory card.

The control unit 140 controls the overall operation of the image forming apparatus 100. In an embodiment of the present general inventive concept, the control unit 140 reads the list of the image data from the memory card in response to a print request signal input by the user through the input unit 110, and displays the list on the display unit 120, whereby the user can choose desired image data to be printed. Also, the control unit 140 may process the image data stored in the memory card in a data format called thumbnail, and can allow the user to choose the desired image data to be printed.

After the user chooses the image data to be printed, the controller 140 shows a print option set-up menu to the user through the display unit 120, so that the user can set print options that the image forming apparatus 100 can support. For example, size of the printing paper, resolutions, and a printing direction may be included in the print options. The control unit 140 controls the printing unit 170 to execute the printing operation based on the print list provided by the print list preparation unit 150.

If the print interrupt request signal is input through the input unit 110 or an external host device (not shown) during the printing operation, the control unit 140 displays a message asking the user whether to prepare a list of unprinted image data (i.e., an unprinted image list) on the display unit 120. If the user chooses to prepare the unprinted image list, the control unit 140 controls the print list preparation unit 150 to prepare the unprinted image list and stores the unprinted image list in the memory card. The external host device (not shown) may be connected to the image forming apparatus 100 through the communication interface 180. Generally, a device, e.g., a computer, which is capable of transmitting the image data to be printed and the command to control the image forming apparatus 100 to the image forming apparatus 100 can be used as the external host device.

Moreover, the control unit 140 displays a message asking the user in which storage location the user wants to store the unprinted image list on the display unit 120 to allow the user to select the storage location. The user can respond to the message asking where to store the unprinted image list through the input unit 110. In another embodiment, the control unit 140 may store the unprinted image list directly in the memory card without displaying the message asking the user to select the storage location.

When the user inputs the print request signal through the input unit 110 or the external host device (not shown) to print image data on the unprinted image list, the control unit 140 checks whether the unprinted image list exists in the memory card or the storage unit 130. If the unprinted image list does exist, the control unit controls the printing unit 170 to execute the printing operation on the image data included on the unprinted image list. On the other hand, if the unprinted image list does not exist in the memory card or the storage unit 130, the control unit 140 displays on the display unit 120 a message informing the user that the unprinted image list is not available.

When the print interrupt request is withdrawn before the print list is deleted from the RAM 133, the control unit 140 can control the print unit 170 to resume the printing operation based on the print list stored in the RAM 133. Before the printing unit 170 actually starts printing the image data on the print list, the control unit 140 can display on the display unit 120 a message asking the user to select whether the user would like to resume the printing operation based on the print list stored in the RAM 133.

The print list preparation unit 150 prepares the print list for the image data to be printed. The print list may be prepared based on image data selected by the user or the print list may be prepared to print every image data contained in the memory card. The print list may include a file name of each of the image data to be printed, information on the print options set for the image data to be printed, and a print sequence of the image data to be printed.

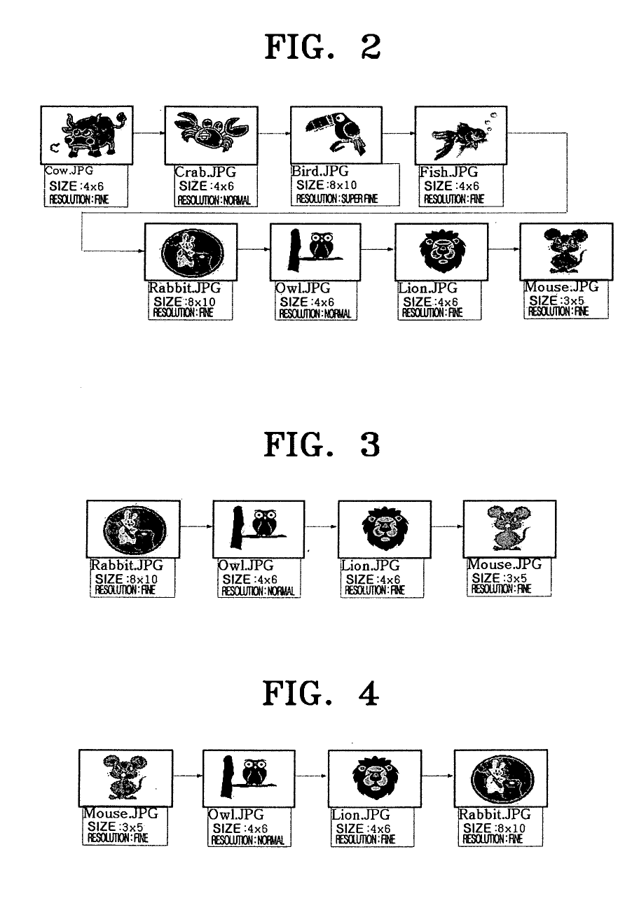

One example of the print list prepared by the print list preparation unit 150 will now be explained with reference to FIG. 2. As illustrated in FIG. 2, the print list includes file names of eight image data that are selected among the image data stored in the memory card (not shown), print options set for the image data to be printed, such as, size of a printing paper, resolution, printing direction and other options provided by the image forming apparatus, and information on the print sequence. The print sequence is illustrated by arrows connecting the images. Thus, the print sequence of FIG. 2 starts with Cow.JPG and ends with Mouse.JPG.

In a case that the printing job is interrupted by the user for some reason, the print list preparation unit 150 prepares the unprinted image list under the control of the control unit 140. One example of the unprinted image list is illustrated in FIG. 3. For convenience, let's assume that the printing job was being executed on the image data illustrated in FIG. 2 and an interrupt command was issued when it was the image data with the file name Rabbit.JPG's turn to be printed. Then, the print list preparation unit 150 prepares the unprinted image list consisting of the image data with the file names Rabbit.JPG, Owl.JPG, Lion.JPG and Mouse.JPG, as illustrated in FIG. 3.

Although FIG. 3 illustrates the unprinted image list to which the same print sequence before the print interrupt request is applied, it is for illustrative purposes only. However, the print sequence may be reset by grouping unprinted image data under the same print options. For example, if the same size of the printing paper or the same resolution is applied to some image data, they can be printed consecutively, whereby the image forming apparatus 100 can execute the printing jobs more efficiently. FIG. 4 illustrates another example of the unprinted image list where image data are rearranged in the order of the paper size.

The memory card interface 160 is designed in a manner to satisfy the physical/logical/electrical interface standards for the memory card inserted into the card slot (not shown), and is in charge of data input/output between the inserted memory card and the image forming apparatus 100.

The printing unit 170 prints images corresponding to the image data input to the image forming apparatus 100 onto printing papers, under the control of the control unit 140.

The communication interface 180 is provided to connect the image forming apparatus 100 with an external host device. Examples of such communication interface may include a parallel port, a USB port, a wireless module, etc. Hence, the communication interface 180 receives the image data by being connected to the host device.

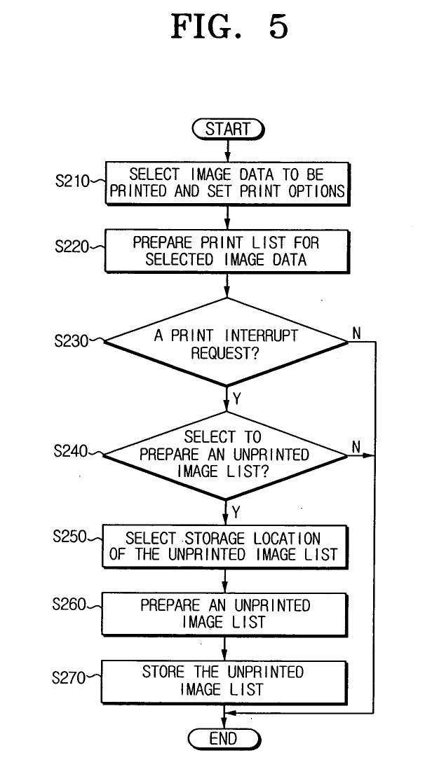

FIG. 5 is a flow chart illustrating a method of storing a list of the unprinted image data in a memory card, which is performed in the image forming apparatus 100 of FIG. 1, according to an embodiment of the present general inventive concept.

Referring to FIGS. 1 and 5, when a print request signal for the image data stored in the memory card is input through the input unit 110 or other means, the control unit 140 displays on the display unit 120 an image data list and a print option set-up menu stored in the memory card, so that the user may select image data desired to be printed and set print options to be applied to the image data to be printed (Operation S210).

Next, the print list preparation unit 150 prepares a print list including file names of the selected image data and the print options and a print sequence set by the user (Operation S220).

Then, the control unit 140 controls the printing unit 170 to execute a printing operation on the image data to be printed based on the print list prepared in Operation S220. And if a print interrupt request signal is input through the input unit 110 or the external host device (not shown), the control unit 140 displays on the display unit 120 a message asking the user to select whether to prepare an unprinted image list (Operation S240).

If the user selects to prepare the unprinted image list in Operation S240, the display unit 120 displays, under the control of the control unit 140, a message asking the user to select where to store the unprinted image list (Operation S250). As described above, the storage location may be either the memory card or the storage unit 130 of the image forming apparatus 100. In another embodiment, the Operation S240 may not be performed and the unprinted image list can be stored directly in a storage location selected by default.

Afterwards, the control unit 140 controls the print list preparation unit 150 to prepare the unprinted image list for image data suspended from printing among the image data to be printed on the print list (Operation S260).

The control unit 140 then stores the unprinted image list provided by the print list preparation unit 150 in the selected storage location that was selected in Operation S250 (Operation S270).

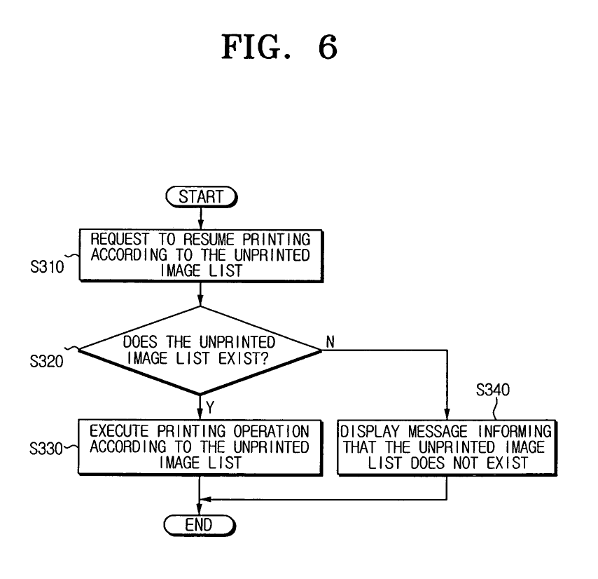

FIG. 6 is a flow chart illustrating a method of printing the unprinted image data stored in a memory card, which is performed in the image forming apparatus of FIG. 1, according to an embodiment of the present general inventive concept.

Referring to FIGS. 1 and 6, when a print request signal requesting to print the image data on the unprinted image list is input (Operation S310), the control unit 140 checks whether the unprinted image list exists in the memory card or the storage unit 130 (Operation S320).

If the unprinted image list of concern is available, the control unit 140 reads the list from the memory card or the storage unit 130, depending on where it is stored, and stores it in the RAM 133. Then, the control unit 140 controls the printing unit 170 to execute the printing operation based on the unprinted image list (Operation S330).

On the other hand, if the unprinted image list does not exist, the control unit 140 displays on the display unit 120 a message informing the user that the unprinted image list of concern does not exist (Operation S340).

Even though the exemplary embodiments of the general inventive concept explained so far have been based on the assumption that the unprinted image list can be prepared when the user makes a print interrupt request through the input unit or an external host device, the unprinted image list may also be prepared and stored in the storage unit or the memory card in other situations, such as when the printing job is interrupted by mechanical errors in the image forming apparatus, e.g., paper jams, a cartridge ink shortage, etc., or other reasons like removing the memory card from the card slot.

Therefore, the present general inventive concept provides an image forming apparatus with which the user can resume the print job any time using the list of the unprinted image data among the image data to be printed to prepare and to store the unprinted image list composed of comprising the image data suspended from printing in the memory card or the storage unit of the image forming apparatus.

As such, the user does not need to repeat selecting the image data to be printed and resetting the print options, to print the unprinted image data afterwards.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling an image forming apparatus, comprising:
obtaining image data to be printed which are selected among image data stored in a memory card;
preparing a print list for the selected image data;
printing the selected image data;
if a printing operation is interrupted, preparing a list of unprinted image data; and
storing the list of unprinted image data.

2. The method of claim 1, wherein the printing of the selected image data comprises preparing a list of image data selected from printing.

3. The method of claim 1, wherein the preparing of the list of unprinted image data is prepared by displaying on a display unit a message asking a user to select whether to prepare the list of unprinted image data and obtaining an affirmative response from the user.

4. The method of claim 1, wherein the storing of the list of unprinted image data comprises storing the list of unprinted image data is stored the memory card and/or a predetermined storage unit provided to the image forming apparatus.

5. The method of claim 4, wherein the storing of the list of unprinted image data comprises selecting in a storage location comprises storing the list of unprinted image data in a memory card or a predetermined storage unit.

6. The method of claim 1, wherein the preparing of the list of unprinted image data comprises at least one of file names of image data suspended from printing, print options, and a print sequence.

7. The method of claim 6, wherein the preparing of the list of unprinted image data comprises rearranging the print sequence in a manner that the unprinted image data having the same print options are grouped together.

8. The method of claim 1, further comprising:
receiving a print resume request to print image data on the list of unprinted image data; and
executing a printing operation on the image data included in the list of unprinted image data.

9. The method of claim 8, further comprising checking whether the list of unprinted image data is stored in the memory card.

10. An image forming apparatus, comprising:
a printing unit to perform a print operation according to image data of a plurality of images;
a control unit to control the print unit; and
a print list preparation unit to prepare an unprinted image list based on a control instruction from the control unit when the print operation stops printing before the print operation for all the image data is completed, the unprinted image list comprising image data of each of the plurality of images not printed in the print operation.

11. The image forming apparatus of claim 10, further comprising:
a storage unit to store image data.

12. The image forming apparatus of claim 11, wherein the storage unit comprises a RAM to store any one of the image data, the unprinted image list, image data from a memory card, and image data of an external host.

13. The image forming apparatus of claim 11, wherein the storage unit comprises a ROM to store control programs of the image forming apparatus.

14. The image forming apparatus of claim 13, wherein the ROM comprises a nonvolatile random access memory and the nonvolatile random access memory stores the unprinted image list.

15. The image forming apparatus of claim 10, further comprising:
a memory card interface to connect a memory card to the image forming apparatus, and
wherein the memory card receives or transmits data to or from the image forming apparatus.

16. The image forming apparatus of claim 10, wherein the control unit controls the printing unit to resume printing according to the unprinted image list.

17. The image forming apparatus of claim 10, wherein the image data includes print options for each of the plurality of images.

18. The image forming apparatus of claim 17, wherein the print options comprise at least one of an image printing paper size, an image name, an image resolution, and an image printing direction.

19. The image forming apparatus of claim 10, further comprising:
an input unit to receive an instruction and to transmit a signal based on the instruction to the control unit, wherein the control unit controls the printing unit based on the transmitted signal.

20. The image forming apparatus of claim 19, wherein:
the transmitted signal is an instruction to stop printing, and the control unit controls the printing unit to stop printing.

21. The image forming apparatus of claim 19, wherein:
the transmitted signal is an instruction to resume printing, and the control unit controls the printing unit to resume printing according to the unprinted image list.

22. The apparatus of claim 10, further comprising:
a display unit controlled by the control unit to display a status of the print operation and a print operation option.

23. An image forming apparatus, comprising:
a control unit to control a print operation based on a command to print image data; and
a print list preparation unit to prepare a print list upon receipt of the command to print the image data from the control unit and to prepare an unprinted image list of image data not printed by the print operation upon an interruption of the print operation.

24. The image forming apparatus of claim 23, wherein the control unit controls a resume print operation based on a command to resume printing of unprinted image data based upon the unprinted image list.

25. An image forming apparatus, comprising:
a printing unit to print image data; and
a print list preparation unit to prepare a list of image data to be printed in a print operation and to prepare a list of unprinted image data when an interruption of the printing of the image data occurs.

26. The image forming apparatus of claim 25, further comprising:
a control unit to control the print list preparation unit to print the list of unprinted data upon a received request signal to resume printing.

27. A method of controlling an image forming apparatus, comprising:
performing a print operation of image data comprising a plurality of images;
generating a list of unprinted image data comprising image data of the plurality of images not printed by the print operation when the print operation is interrupted; and
storing the list of unprinted image data to be printed at a later time.

28. The method of claim 27, further comprising:
displaying a status of the print operation and a print operation option to a user on a display unit.

29. The method of claim 27, further comprising:
resuming the print operation by printing the list of unprinted image data upon receipt of a command to resume the print operation.

30. The method of claim 29, wherein the resuming the print operation further comprises checking if the list of unprinted image data exists and if the list of unprinted image data does not exist displaying a message that indicates the list of unprinted image data does not exist.
